(19) United States
(12) Patent Application Publication
(10) Pub. No.: US 2005/0089646 A1
(43) Pub. Date: Apr. 28, 2005

(54) Method of coating the bead seat of a wheel to reduce tire slippage

(76) Inventors: Mark Thomas Endicott, Mooresville, NC (US); Randall John Wischhusen, Chesterland, OH (US)

Correspondence Address: Mark Endicott, 333-A Rolling Hills Rd., Mooresville, NC, 28117, US

(21) Appl. No.: 10/695,127

(22) Filed: Oct. 28, 2003

(51) Int. Cl. H05H 1/24

(52) U.S. Cl. 427/446; 427/569; 427/299

(57) ABSTRACT

A method for coating the bead seat of a wheel with a hard, rough, friction coating is disclosed. This coating is intended to prevent the tire from slipping on the rim of the wheel. The coating can be applied via several methods including thermal spray techniques. The ability to keep the tire from slipping on the wheel is particularly important for low-pressure tires, which are vulnerable to slippage during acceleration and for truck tires, which are vulnerable during braking. Furthermore, the method disclosed requires no additional mechanically attached parts and requires no special installation.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF INVENTION

The inside edge of automobile and truck tires typically contain a beaded area. The rim of an automotive wheel, onto which a tire is mounted, has a flange on the interior, or bead seat. The internal air pressure of the tire keeps a tight seal between the bead of the tire and the bead seat of the rim. For most driving conditions, this configuration suitably keeps the tire inflated on the wheel. Certain conditions, however, such as racing and off-road driving utilize tires with low air pressure to maximize the contact area between the tire and the road and thus improve traction. Under these conditions, the tire may move or slip on the bead seat of the wheel, especially during sharp accelerations. This slippage results in decreased performance and could lead to a loss of pressure within the tire and possibly the slippage of the wheel off of the rim. In addition, there are conditions in which tires may slip on wheel rims during deceleration, such as sharp braking of over the road trucks.

This invention provides for a wheel with a bead seat that has been coated such that tire slippage is reduced or eliminated. This invention is a new and novel approach that eliminates the drawbacks of the prior art methods of tire retention on wheels. These methods have been either complex, multi-component methods of mechanically fastening tires to rims, or simple and only minimally effective.

There are numerous examples of bead lock technology in which a form of a clamp is utilized to keep the tire from slipping on the rim. Some examples include U.S. Pat. No. 4,552,194, U.S. Pat. No. 4,709,738, U.S. Pat. No. 4,797,987, U.S. Pat. No. 4,989,657, U.S. Pat. No. 5,984,421, and the use of rim screws, which are fastened through the rim and a metal ring that sits inside the tire bead. Each bead lock mechanism requires the use of additional materials, such as retaining rings, which are used to mechanically clamp the tire bead to the bead seat of the wheel. This type of bead locking technology can be effective, although the extra clamping components are typically complex, add weight to the vehicle, and could become hazardous projectiles in the case of a crash. The technology utilized in the present invention, that of a friction coating on the bead seat of the rim, requires no additional clamping mechanisms and no additional assembly steps to install tires.

The ability to reduce or eliminate slippage of tires on automotive and truck wheels has many advantages. The ability to retain the proper air pressure within the tire is important both to automotive performance and to safety. Proper air pressure ensures the correct contact area between the tire and the road surface and keeps the tire from detaching from the wheel rim In addition, some automobiles, such as those used for racing, utilize tire weights to maintain the desired balance. In preventing slippage of the tires, these weights are also secured in their correct positions. While it is always important to prevent slipping of the tires, this is especially so during the initial acceleration of the automobile from a stationary position. At this time, the tires may be cold, and as such the bead of the tire is harder and less pliable than a warm tire, and thus more prone to slippage. Another situation in which the invention is useful is during braking or deceleration, which can also lead to slippage of tires on rims, particularly for over the road trucks.

### BRIEF SUMMARY OF THE INVENTION

The present invention provides for a wheel in which the bead seat of the rim is coated with a hard, rough, friction coating intended to prevent the tire from slipping. In one embodiment, the bead seat is coated via a thermal spray process with a refractory metal. In another embodiment, the bead seat area is abrasively blasted prior to coating to provide for a rough surface. In another embodiments, the coating is applied by a plating or deposition method.

### BRIEF DESCRIPTION OF THE SEVERAL VIEWS OF THE DRAWING

Not Applicable

### DETAILED DESCRIPTION OF THE INVENTION

According to the present invention, the bead seat area of vehicle wheels are grit blasted in preparation for thermal spray surface treatment. A coating is then applied via a thermal spray technique, such as plasma spray, oxy-fuel thermal spray or wire spray. The coating can be a refractory metal, although an alloy, a cermet, carbide, ceramic or other like material can be used. In one embodiment, the application of the coating is such that it is bonded well with the wheel and the surface finish is rough. This rough coating, obtained from the grit blasting, the thermally applied coating or both, provides for a surface onto which the tire bead grips and maintains its position on the tire without slipping.

### EXAMPLE 1

### An Automotive Wheel was Prepared via the Following Procedure

a) The bead seat of the wheel was abrasively blasted to create a surface roughness of 200+/−25 microinches. Surfaces other than the bead seat were masked off with thermal tape.
b) A thermal plasma torch was used run on an N₂H₂ gas mixture at 30 kW using a 5-inch spray distance and a powder flow rate of 12 pounds per hour. In this example, a chrome carbide alloy, −100/+325 mesh size was the coating material.
c) Excess powder was brushed off the wheel, the masking removed, and the coating sealed with a phenolic sealer to prevent air leakage through the coating.
d) The tire was fitted to the wheel and the wheel mounted on a short-track racing automobile.

The racing automobile of example 1 was compared with similar racing automobiles that used standard non-treated wheels. Prior to the initial acceleration of these automobiles onto the track, a mark was made on the tire and wheel with a paint pen to indicate their initial positions. After the automobiles accelerated onto the track, they were stopped and the marks inspected. For the automobile fitted with standard, non-treated wheels, the mark on the wheel and tire now were separated by 0.5-inches, indicating this amount of slippage. For the automobile fitted with the tires in which the bead seats were treated, the mark on the tire and wheel still lined up, indicating no discernable slippage.

Although the example disclosed here utilizes a thermal spray method to apply the friction coating to the bead seat of the wheel, it is acknowledged that several alternate methods of coating this surface may be utilized. These may include, but are not limited to plating, vapor deposition, and the use of adhesives as well as other techniques. In addition, other metals or metal alloys besides chrome carbide may be utilized, including, but not limited to other metals, ceramics or composites. In addition, any powdered or suspending particles of sufficient grit can be used as part of a coating. Furthermore, while the example uses a spray method to apply the friction coating, other methods such as immersion may be used.

It is recognized that while the present invention has been described with reference to preferred embodiments, various details of the invention can be changed without departing from the scope of the invention. Furthermore, no limitations are intended to the details of the process described, other than as described in the claims below.

1. A method of reducing the slip of a tire on a vehicle wheel comprising:
a. providing a metallic wheel, and
b. coating the bead seat surface of the wheel with rough, hard material, whereby the friction between the tire and said wheel is increased thus reducing slip.

2. The method of claim 1 wherein said vehicle wheel is selected from the group consisting essentially of automobile wheel, truck wheel, motorcycle wheel, train wheel, aircraft wheel and bicycle wheel.

3. The method of claim 1 wherein said rough, hard material is selected from the group consisting essentially of cermets, metals, ceramic, or composite materials.

4. The method of claim 1 wherein said coating is applied via a thermal spray technique selected from the group consisting essentially of oxy-fuel thermal spray, oxy-fuel wire spray, plasma spray, high velocity oxy-fuel (HVOF), and twin-wire arc spray.

5. The method of claim 1 wherein said rough, hard coating is applied by means of an adhesive.

6. A method of reducing the slip of a tire on an automotive or truck wheel comprising:
a. providing a metallic wheel, and
b. abrasively blasting the bead seat of the wheel thus increasing the surface roughness, and
c. coating the bead seat surface of the wheel with rough, hard material, whereby the friction between the tire and said wheel is increased thus reducing slip.

7. The method of claim 6 wherein said coating is selected from the group consisting essentially of cermets, metals, ceramic, or composite materials.

8. The method of claim 6 whereby said coating is applied via a thermal spray technique selected from the group consisting essentially of oxy-fuel thermal spray, oxy-fuel wire spray, plasma spray, high velocity oxy-fuel (HVOF), and twin-wire arc spray.

9. A vehicle wheel in which the surface of the bead seat of said wheel is rough, whereby slippage of a tire on said wheel is reduced.

10. The method of claim 9 wherein said vehicle wheel is selected from the group consisting essentially of automobile wheel, truck wheel, motorcycle wheel, train wheel, aircraft wheel and bicycle wheel.

11. The method of claim 9 wherein said rough surface is a coating of a material selected from the group consisting essentially of cermets, metals, ceramic, or composite materials.

12. The method of claim 9 wherein said rough surface is a coating that is applied to said bead seat via a thermal spray technique selected from the group consisting essentially of oxy-fuel thermal spray, oxy-fuel wire spray, plasma spray, high velocity oxy-fuel (HVOF), and twin-wire arc spray.

13. The method of claim 9 wherein said rough surface is a coating applied to said bead seat by means of an adhesive.

14. The method of claim 9 wherein said rough surface is formed by abrading, machining or otherwise mechanically treating said bead seat.
